(19) United States
(12) Patent Application Publication
(10) Pub. No.: US 2001/0001935 A1
(43) Pub. Date: May 31, 2001

(54) METHOD AND APPARATUS FOR CUT GROOVING AND CHAMFERING A CYLINDRICAL PIPE SECTION

(76) Inventors: CHARLES E. WILK JR., WHITEHALL, PA (US); DOUGLAS R. DOLE, WHITEHOUSE STATION, NJ (US)

Correspondence Address: ABELMAN FRAYNE & SCHWAB, ATTORNEYS AT LAW, 150 EAST 42ND STREET, NEW YORK, NY, 10017, US

(21) Appl. No.: 09/313,163

(22) Filed: May 17, 1999

(51) Int. Cl. B23B 5/16; B23B 5/00

(52) U.S. Cl. 82/113; 82/123

(57) ABSTRACT

An apparatus is disclosed for end cutting and cut grooving a cylindrical pipe section, which includes a support frame, and a plurality of rollers adapted for positioning and gripping the pipe section for cutting and grooving portions thereof in fixed predetermined relation with respect to the frame. A chamfer cutting tool is arranged for cutting at least portions of the end of the pipe section to a predetermined shape, the chamfer cutting tool being positioned at a predetermined location with respect to the frame. A groove cutting tool is mounted for cutting a groove in the outer surface portion of the pipe section, the groove cutting tool being positioned at a predetermined location with respect to the frame. Means is included for providing relative rotation between the frame and the pipe section to permit the chamfer cutting tool and the groove cutting tool to cut the pipe section. A method of cut grooving and chamfering the pipe section is also disclosed.

### BACKGROUND OF THE INVENTION

1. Field of the Invention

The present invention relates to an apparatus for simultaneously cut grooving and chamfering a cylindrical pipe section. The invention also relates to a method for cut grooving and chamfering the cylindrical pipe section.

2. Description of the Related Art

Present day conduit systems are generally formed of pipe sections, elbows, or the like which are connected to each other by specifically designed couplings. The couplings often require specifically sized pipe sections, elbows, or the like, and in addition, require specifically dimensioned grooves and chamfers to accommodate the connections.

Accordingly, devices to provide grooves and chamfers in pipe sections for such conduit systems are known. However, to date, such devices have not been provided with the capability to simultaneously cut groove and chamfer a pipe section with a relatively uncomplicated structure, yet having the versatility to select either cut grooving or chamfering, while having the ability to perform such operations on workpieces of various sizes without the need to change the device.

U.S. Pat. No. 5,641,253 to Wagner relates to a tube chamfering device which includes a chamfering tool having a cutting edge which corresponds to the chamfer angle desired. The tool is positioned within the tube to be chamfered and rotated and pushed in the axial direction to chamfer the end of the workpiece. U.S. Pat. No. 2,634,643 to Kroos relates to a pipe grooving tool which is arranged to support a pipe section to be cut by a groove cutter which moves radially inward while the tool is revolved about the workpiece. Each tool is adapted for a workpiece of a specific size.

U.S. Pat. No. 3,699,828 to Piatek et al. relates to a pipe groover which includes a series of inner and outer support rollers and a radial groove cutting tool. U.S. Pat. No. 1,256,556 to Hedges relates to a pipe cutting and grooving machine which forms a groove in a pipe section with a radially movable groove cutter, while cutting and removing the end of the pipe section. The pipe end cutting device is a cutting tool which rotates on its own axis while being rotated about the workpiece, whereby the workpiece is actually cut by the rotating cutter and the edge of the section removed therefrom has a bevelled configuration. The bevel formed in the piece removed is a relatively high angle bevel, i.e. about 60°to the axis of the pipe section, as compared to the relatively shallow chamfer required in modern day pipe coupling connections.

Lastly, U.S. Pat. No. 3,247,743 to Frost et al. relates to a pipe cutter which utilizes a rotating toothed cutter. We have invented an apparatus for cut grooving and chamfering a cylindrical pipe section which is relatively uncomplicated, utilizes generally radially inwardly movable cutters, while being rotated about the pipe section. The apparatus of the invention provides the capability of selecting one or the other cutting operation without adversely affecting the cutting procedure selected.

### SUMMARY OF THE INVENTION

The invention relates to an apparatus for end cutting and cut grooving a cylindrical pipe section, which comprises a support frame, means for positioning and gripping the pipe section for end cutting and grooving portions thereof in fixed predetermined relation with respect to the frame, end cutting means for cutting at least portions of the end of the pipe section to a predetermined shape, the end cutting means being positioned at a predetermined location with respect to the frame. Groove cutting means is provided for cutting a groove in the outer surface portion of the pipe section, the groove cutting means being positioned at a predetermined location with respect to the frame. Means is provided for providing relative rotation between the frame and the pipe section to permit the end cutting means and the groove cutting means to cut the pipe section. Preferably the end cutting means is a cutting tool mounted and arranged for generally radial movement toward and away from the pipe section to cut a chamfer into the end of the pipe section. Preferably the groove cutting means is a cutting tool mounted and arranged for generally radial movement toward and away from the pipe section and the means for positioning and gripping the pipe section is a plurality of grip rollers selectively movable toward and away from the pipe section for gripping the pipe section.

In the preferred embodiment, the grip rollers comprise at least two rollers positionable against the inner surface of the pipe section and two rollers positionable on the outer surface of the pipe section. However, the invention may be practiced with one roller on the inner surface and one roller on the outer surface, or various combinations of rollers on the inner and outer surfaces as may be required in each instance.

The two rollers positionable on the outer surface of the pipe section are mounted to a cross member extending transversely to the axis of the pipe section and movable toward and away from the pipe section respectively to grip the pipe section and to release the pipe section, and at least two grip rollers positionable against the inner surface of the pipe section each have a frusto-conical configuration. The chamfer cutting tool is attached to a threaded rod member movable toward and away from the pipe section, and the groove cutting tool is attached to a threaded rod member movable toward and away from the pipe section. One frusto-conical roller is attached to a rotational drive member to rotate the roller. With the pipe section held fixed, as for example, in a vise, the rollers and the frame will rotate around the pipe section when the rotational drive member is rotated and the cutting process proceeds. The rotational drive member includes a drive nut attached thereto which is rotatable by rotational engagement therewith by a nut driving member, and the transverse cross member is attached to a threaded rod member movable toward and away from the pipe section, the threaded rod member having a drive nut attached to one end thereof for rotatably driving the threaded rod member with a nut driving tool. The chamfer cutting tool has a cutting stop associated therewith to prevent chamfer cutting past a predetermined depth, and the groove cutting tool has a cutting stop associated therewith to prevent further groove cutting past a predetermined depth.

A method is disclosed for cut grooving and chamfering a cylindrical pipe section on a support frame having means for positioning and gripping the pipe section in a manner which provides relative rotation between said support frame and the pipe section when at least one of said gripping means is rotated, comprising, providing end cutting means for chamfer cutting at least portions of the end of the pipe section to a predetermined shape, the end cutting means being positioned at a predetermined location with respect to the frame and having means to bias the end cutting means toward the pipe section when the frame is mounted on the pipe section. The method further comprises providing groove cutting means for cutting a groove in the outer surface portion of the pipe section, the groove cutting means being positioned at a predetermined location with respect to the frame and having means to bias the groove cutting means toward the pipe section when the frame is mounted on the pipe section, and providing relative rotation between the frame and the pipe section to permit the end cutting means and the groove cutting means to progressively cut the pipe section under the bias forces. Preferably the end cutting means is a chamfer cutting tool, and the groove cutting means is a groove cutting tool. The method may be practiced by simultaneously cut grooving and chamfering the pipe section, or separately and independently cut grooving and chamfering the pipe section, as may be required.

### BRIEF DESCRIPTION OF THE DRAWINGS

Preferred embodiments of the invention are described hereinbelow with reference to the drawings, wherein:

FIG. 1 is a rear right perspective view from above, of the apparatus for cut grooving and chamfering a pipe section constructed according to the invention;

FIG. 2 is a view partially in cross-section, taken along lines 2-2 of FIG. 1 and rotated approximately 180°in the direction opposite from the direction in FIG. 1, with the apparatus positioned on the pipe section intended for cut grooving and chamfering;

FIG. 3 is a view, partially in cross-section, taken along lines 3-3 of FIG. 2;

FIG. 4 is a partial cross-sectional view taken along lines 4-4 of FIG. 2;

FIG. 5 is an elevational cross-sectional view from the right side, illustrating the groove cutting portion of the apparatus in enlarged detail, the chamfer cutting portion being cut away for illustration purposes;

FIG. 5A is a frontal cross-sectional view, taken along lines 5A-5A of FIG. 5, illustrating the groove cutting block shown in FIG. 5, and the preferred method of providing relative rotation between the apparatus and the pipe to cut a groove into the pipe;

FIG. 6 is an elevational cross-sectional view from the right side, illustrating the chamfer cutting portion of the apparatus in enlarged detail, the groove cutting portion being cut away for illustration purposes;

FIG. 6A is a rearward cross-sectional view, taken along lines 6A-6A of FIG. 6, illustrating the pipe end chamfer cutting device, and the preferred method of providing relative rotation between the apparatus and the pipe to cut a chamfer on the end of the pipe simultaneously with the cutting of a groove into the pipe wall; and

FIG. 7 is a right side perspective view from below, of the apparatus for cut-grooving and chamfering of a pipe section according to the invention, illustrating the completed workpiece pipe section after removal of the apparatus from the workpiece.

### DETAILED DESCRIPTION OF THE PREFERRED EMBODIMENTS

In the description which follows, reference is made to the front, rear, right side and left side of the apparatus. The front of the apparatus faces the workpiece and the rear side receives the manually operable crank. The right and left sides are defined as viewed from the positions of the workpiece. Furthermore in the description which follows, reference is made to a chamfering procedure whereby the end of pipe section is chamfered at a relatively shallow angle, such as about 10-25°, with respect to the longitudinal axis of the pipe section, in contrast to a bevelling operation wherein the angle is approximately 60-75°with respect to the axis of the pipe section 12.

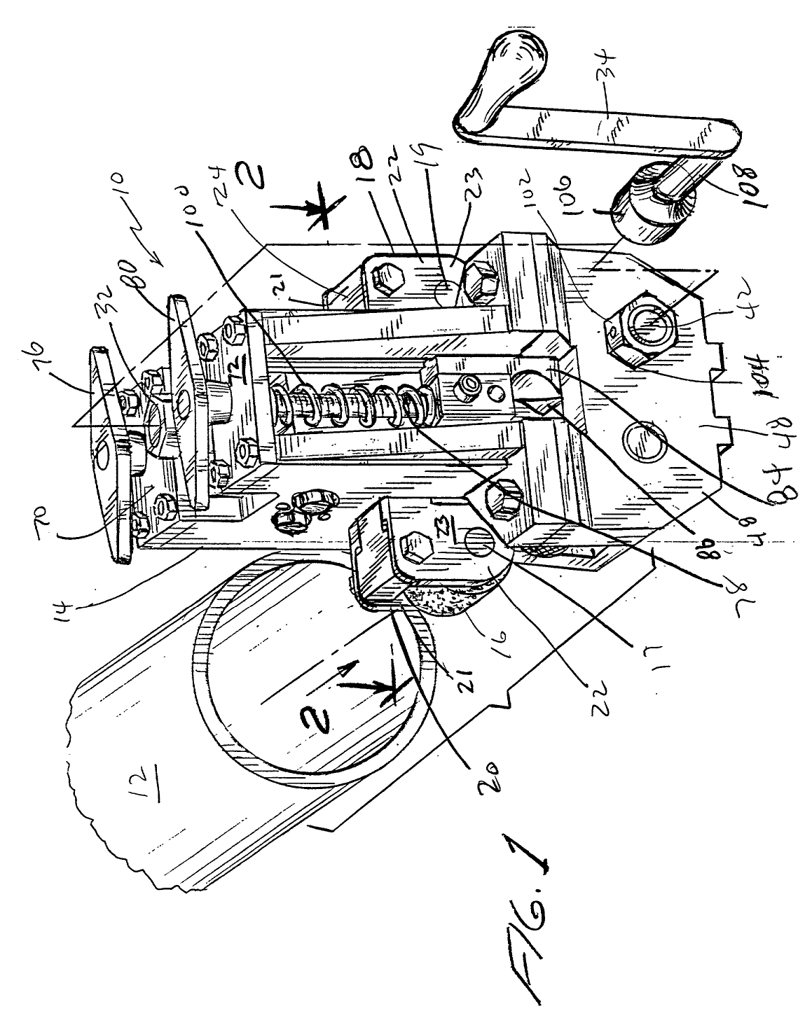

Referring to the drawings and in particular to FIG. 1, an apparatus 10 for cut-grooving and chamfering a workpiece pipe section 12 is illustrated. The pipe section 12 is separated from the apparatus 10 and is shown in fixed position for reception of the cutting section of the apparatus thereon for the purpose of performing the cut-grooving and chamfering operation on the pipe section 12. The pipe sections primarily contemplated are made of polyvinyl chloride (PVC), chlorinated polyvinyl chloride (CPVC), polyethylene, polybutylene or the like. However the apparatus can also be made to cut-groove and chamfer metal pipe sections.

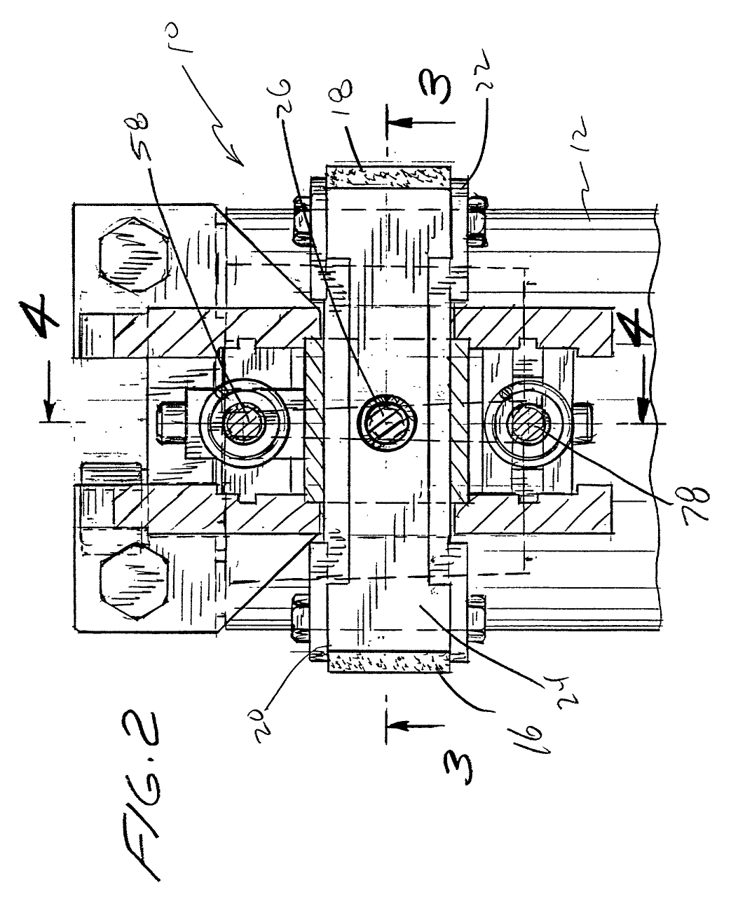

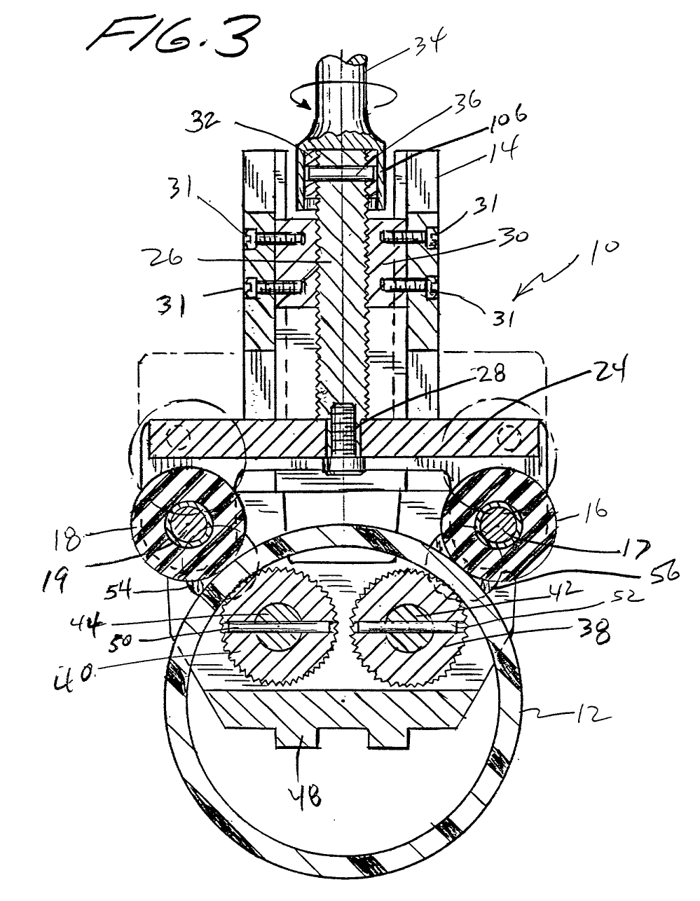

Referring now to FIGS. 2 and 3 in conjunction with FIG. 1, the structural components which form the apparatus 10 will now be described. Apparatus 10 includes frame 14 which consists substantially of cast aluminum. Outer support rollers 16, 18 are rotatably supported on shafts 17, 19, in two roller housings formed by plates 20, 22 which include downwardly extending roller carrying members 21, 23 on each side as shown, and are attached to roller support cross-member 24 which is movable vertically by rotation of threaded rod 26 which is attached thereto by screw 28 and which is threadedly engaged within threaded block 30 which is fixed to frame 14 as shown, by screws 31. Outer support rollers 16, 18 may be made of steel, hard plastic or rubber, or the like, but are required to develop frictional forces with the outer surface of pipe section 12. Accordingly, they may be optionally roughened by stippling, knurling or the like. Threaded rod 26 has a drive nut 32 connected at the upper end as shown, which is rotatable by universal drive crank 34, shown in FIG. 1. As shown in FIG. 3, drive nut 32 is pinned to threaded rod 26 by cross-pin 36 such that rotation of drive nut 32 produces rotation of threaded rod 26. Rotation of rod 26 in one direction produces upward movement of cross-member 24 and grip rollers 16, 18 to release the pipe 12 from apparatus 10, and rotation of the threaded rod 26 in the opposite direction produces downward movement of cross-member 24 and grip rollers 16, 18 to grip the pipe 12 in a manner as will be described.

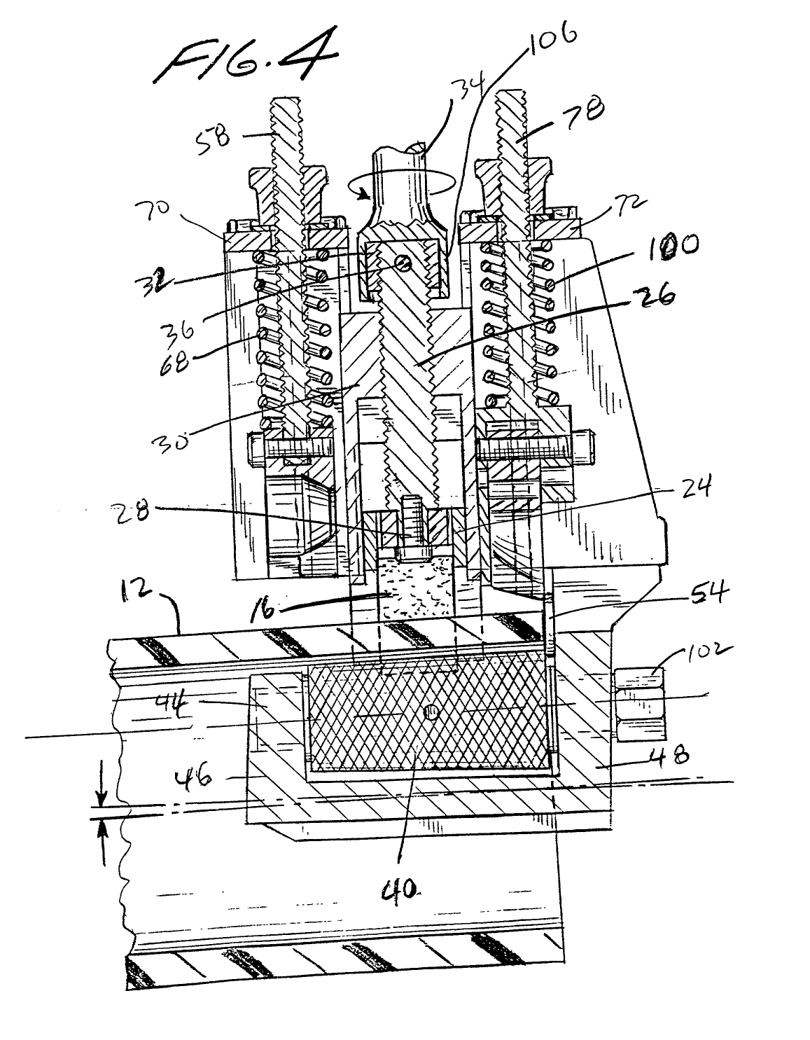

Referring now to FIG. 3 in conjunction with FIGS. 1, 4, and 7, inner gripping rollers 38, 40 are illustrated. Inner rollers 38, 40 are knurled steel rollers having a frusto-conical outer configuration and are fixed for rotation with shafts 42, 44 by pins 50, 52 as shown. As shown in FIG. 4, inner rollers 38, 40 each have a greater diameter at the rearward end than that of the forward end. The steel rollers 38, 40 are intended for engagement with the inner surface of the workpiece pipe section 12 as shown in FIG. 3 and are supported between upwardly extending front flange 46 and rear wall 48 of frame 14 as best shown in FIG. 4. It should be noted that although the preferred combination of grip rollers 16, 18, 38, 40 include a total of four rollers, nevertheless the invention may be practiced utilizing one or more rollers on the outside surface of pipe section 12 and one or more rollers on the inside surface of pipe section 12.

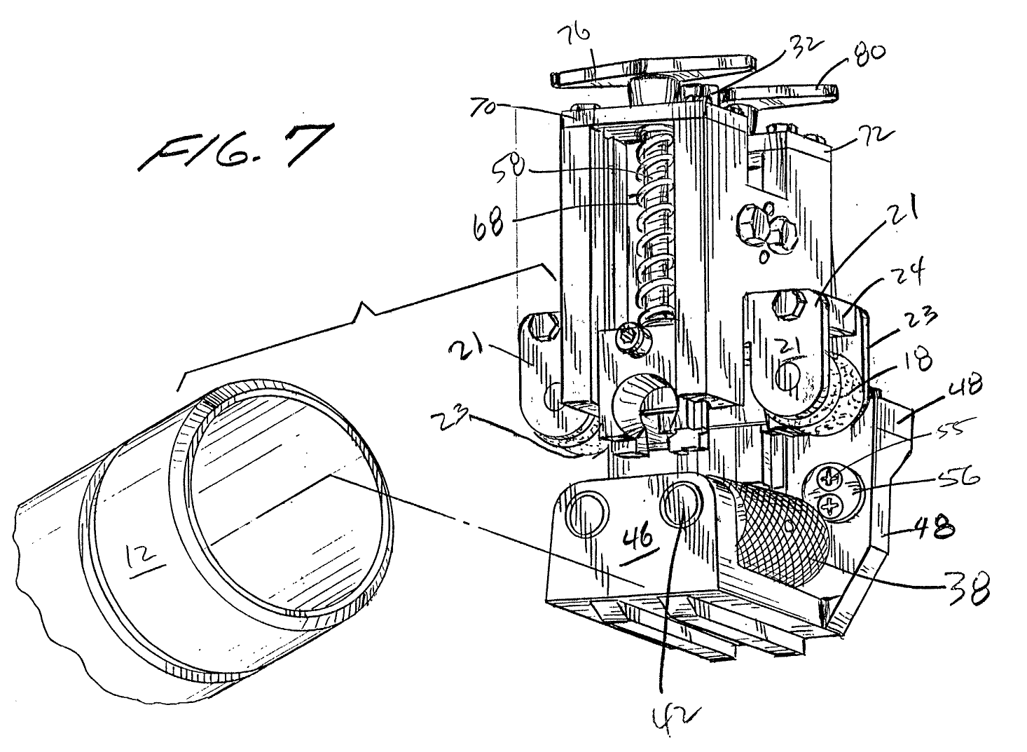

Rear wall 48 of frame 14 includes pipe stops 54, 56 which are in the form of steel discs as best shown in FIG. 7, attached to the rear wall by screws 55 as shown. The purpose of the steel discs 54, 56 is to provide wear-resistant stops for the workpiece pipe section 12, thereby avoiding direct engagement between the pipe 12 and the cast aluminum wall 48 to fix the position of the pipe 12 with respect to the apparatus for precision cutting of the pipe on the end to be chamfered and for cut-grooving on the surface as will be described in further detail herebelow.

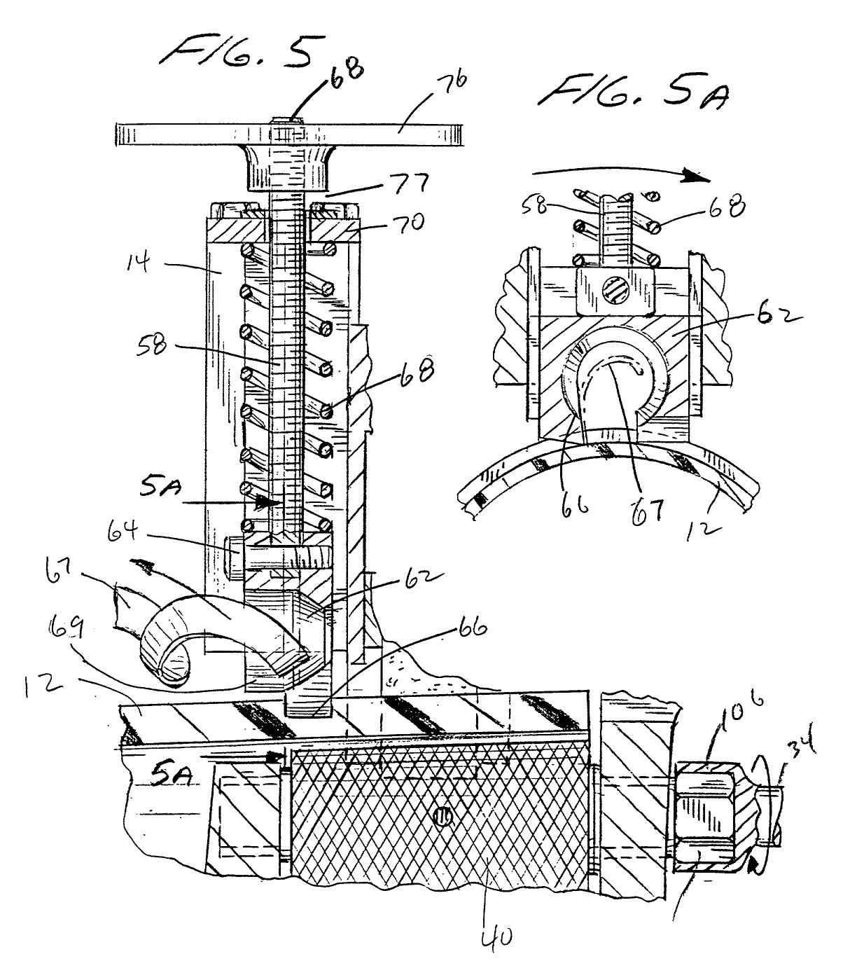

Referring now to FIG. 5 in conjunction with 5A, there is shown an elevational cross-sectional view from the right side, illustrating the groove cutting portion of the apparatus for cutting a groove into the pipe section 12 as shown. Threaded rod 58 is supported vertically within frame 14 and is threadedly engaged at the upper end by threaded handle 76. Groove cutting block 62 is fixed to rod 58 by pin bolt 64 and has a groove cutting knife-edge portion 66 and a groove stop 69 to stop the groove cutting when the groove reaches a predetermined depth. Groove cutting block 62 is biased downwardly in a groove cutting direction by coil spring 68 which is engaged for compression at the upper wall 70. Cutting knife-edge portion 66 of cutting block 62 is dimensioned to cut a groove into pipe section 12 according to the predetermined widthwise and depthwise dimension such as is shown. However, alternatively, cutting block 62 may be configured to have a cutting knife-edge portion 66 of different dimensions or, alternatively positioned to vary the location of the groove with respect to the pipe end. For example, plastic pipe sections to be cut for use with couplings will vary in radial size and wall thickness. Accordingly, depending upon the size of the pipe and the wall thickness, the groove to be cut into the pipe will vary somewhat in depth and in location with respect to the pipe end. Therefore, cutting block 62 can be removed by removal of screw 64 and replaced with a cutting block of different shape and dimensions.

Referring again to FIG. 5 in conjunction with FIG. 5A, cutting block 62 is initially lifted out of the pipe cutting area by rotating threaded handle 76 to cause threaded rod 58 and cutting block 62 attached thereto to be lifted upwardly until the pipe outer surface is cleared by the cutting edge 66. This permits mounting of the apparatus 10 onto the pipe section 12 as will be described hereinbelow. FIGS. 5 and 5A illustrate the groove cutting operation in which pipe material 67, 85 is continuously and progressively cut away from the pipe section 12 as will be described.

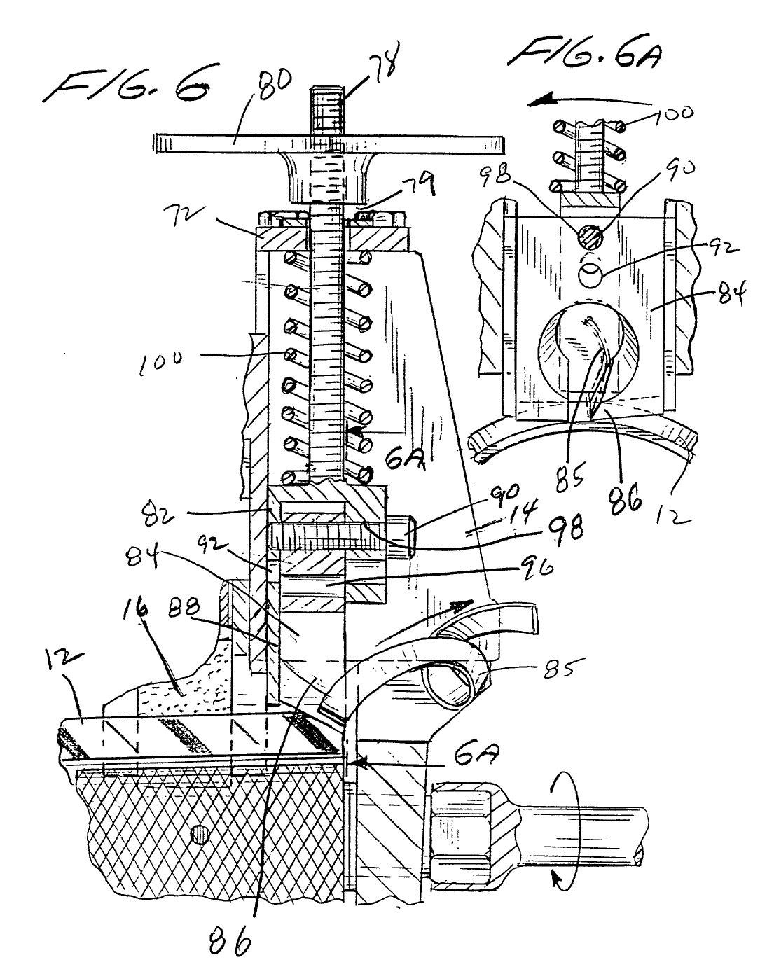

Referring now to FIGS. 6 and 6A, the pipe end chamfering portion of the apparatus is illustrated and is similar to the pipe cut-grooving portion. In FIG. 6, threaded rod 78 is supported vertically within frame 14 and is threadedly engaged by handle 80 at the upper end as shown. Flange member 82 is integrally attached to rod 78 at the lower end and connects chamfer cutting tool 84 to the rod 78. Cutting tool 84 has a chamfered cutting edge 86 at the lowermost end. Flange 82 includes a cutting stop plate 88 having dual positioning apertures 90, 92 which provide dual alternative ranges for cutting tool 84, depending upon which aperture 98 or 92 is used to attach the cutting tool 84 to the flange member 82 and rod 78. Thus by removing pin bolt 90 from flange 82 and repositioning the cutting tool 84 such that aperture 92 becomes aligned with the lowermost aperture 96 in cutting tool 84, the stop plate 88 will engage the surface of the pipe 12 during the chamfering operation earlier than the engagement which would take place when the pin bolt 90 is located in the uppermost aperture 98 as shown. Thus, the stop plate 88 is intended to control the depth of the chamfer which is cut by cutting tool 84 by selectively engaging the outer surface of pipe 12 when a predetermined chamfer cut has been made. In FIGS. 6 and 6A, rod 78 is surrounded by coil spring 100 which biases the chamfer cutting tool 84 in a downward direction by engagement with flange 82 attached to cutting tool 84 via pin bolt 90 at the lower end and with upper wall 72 of frame 14 in a manner similar to the groove cutting section as shown.

Referring now once again to FIG. 1 in conjunction with FIGS. 4 and 6, the drive section of the apparatus will now be described. Conical shaped roller 40 is fixedly connected to shaft 44 by pin 50 as described previously. Shaft 44 extends through the rear wall 48 and is supported thereby for rotation. Shaft 44 has a drive nut 102 connected for rotation therewith by pin 104 best shown in FIG. 1. Alternative drive arrangements for rollers 16, 18, 38, 40 are contemplated for use by those skilled in the art. In addition, provided the pipe section 12 is held fixed as in a vise or other appropriate gripping device, any suitable mechanism or arrangement for rotating the frame 14 would be satisfactory. If appropriate or preferred, the frame 14 may be held fixed, whereby the pipe section 12 will rotate as the cutting operation proceeds.

Crank 34 has an appropriately sized nut drive 106 is positioned at the end of horizontal drive member 108 such that when drive nut 106 is positioned in engagement with nut 102 and crank 34 is rotated manually, the frusto-conical roller 38 also rotates therewith. The frusto-conical rollers 38, 40 are particularly tapered as shown in order to skew the pipe section 12 as shown when the apparatus is placed upon the pipe section for the cutting operation as will be described hereinbelow. The purpose of the tapered configuration of rollers 38, 40, i.e., the forwardmost diameter is less than the rearmost diameter, is to develop self-tracking forces on the pipe section 12 when relative rotation takes place between the pipe section 12 and the rollers 38, 40. The tracking forces are sufficient to cause the pipe section 12 to tend to spiral further into engagement with pipe stops 54, 56 thereby biasing the pipe section 12 toward the frame 14 in order to assure that the cutting operations take place in precisely the predetermined locations without variation from pipe to pipe. The self-tracking feature is described in commonly assigned U.S. Pat. No. 5,279,143, the disclosure of which is incorporated herein by reference.

Referring once again to the drawings, the operation of the apparatus 10 will now be described. A pipe section 12 shown in FIG. 1, is typically made of a plastic material such as polyvinylchloride, chlorinated polyvinyl chloride, or the like. As noted, the pipe section 12 is generally intended for use in coupling applications with other conduits to provide fluid-tight connections for fluids under pressure. In order to connect the pipe section to the other conduits, suitable couplings are used which include appropriate fluid seals. The couplings are of the type which generally require that the pipe section has a chamfered end portion and a groove cut into the wall at a predetermined distance from the chamfered end axially along the tube. The purpose of the chamfered end and the groove is to accommodate particular types of well-known couplings. The precise dimensions of the groove, as well as the location of the groove with respect to the pipe end, and the depth of the chamfer will generally depend upon the size of the pipe section (i.e., nominal diameter and wall thickness). For example, plastic pipe sections are generally supplied in nominal sizes such as 4-6 inches, 8 inch, 10 inch, and 12 inch, etc. Each size requires a specific groove and chamfer and a specific axial dimension between the groove and the chamfer. Accordingly, where appropriate, definitively sized and spaced cutters are required.

Referring again to the drawings, particularly FIG. 1, pipe section 12 is generally fixed in a pipe grip or vise and apparatus 10 is then positioned on the pipe section 12 for proceeding with the cut-grooving and chamfering operation. Prior to positioning the apparatus 10 on the pipe section 12, handles 76 and 80 are rotated in a clockwise direction to cause threaded rods 58, 78 to move upwardly thereby lifting groove cutting tool 62 and chamfering tool 84 upwardly sufficiently to clear the outer surface of pipe section 12 for positioning the apparatus thereon.

Crank 34 is then moved to the top of the apparatus and nut drive 106 is then positioned on drive nut 32 and rotated in a counterclockwise direction which causes threaded rod 26 to rotate and rise so as to lift cross-member 24 and grip rollers 16, 18 upwardly to clear the outermost dimension of pipe section 12. The apparatus is then positioned onto the fixed pipe section 12 and made to grip the pipe section as will be described.

After positioning the apparatus on the pipe section 12, crank 34 is rotated manually in a clockwise direction as shown in FIG. 3 to cause the rod 26 and cross member 24 to be lowered toward the pipe section until outer grip rollers 16, 18 engage the outer surface of the pipe section 12 and cause the inner frusto-conical rollers 38, 40 to engage the inner surface of the pipe section 12 as best shown in FIG. 3. Rotation of crank 34 is continued until the pipe section 12 is gripped between outer rollers 16, 18 and inner rollers 38, 40.

After completion of the pipe gripping operation, crank 34 is then removed from nut 32 and nut drive 106 is then positioned on conical roller drive nut 102. Thereafter, handles 76, 80 are rotated counterclockwise sufficient to cause threaded rods 58, 78 to be lowered until groove cutting tool 62 and chamfer cutting tool 84 engage the appropriate respective outer surface portions of the pipe section 12 with the full downward cutting force provided by springs 68, 100. As shown in FIGS. 5 and 6 handles 76, 80 are rotated counterclockwise sufficient to leave a space 77, 79 which is slightly greater than the anticipated downward movement of cutting tools 62, 84 in order to avoid interference with the downward bias of springs 68, 100.

When the cutting blocks are in engagement with the pipe section 12 as described, crank 34 is rotated to cause rotation of frusto-conical roller 40 which grips the inner surface of pipe section 12. This rotation in turn causes the entire apparatus 10 to rotate about the fixed pipe section 12 while cutting edge 66 of groove cutting tool 62 continuously and progressively cuts a groove into pipe section 12 as shown in FIGS. 5 and 5A, and chamfer cutting tool 84 continuously and progressively cuts a chamfer on the pipe end as shown in FIGS. 6 and 6A. In the cutting of the groove shown in FIGS. 5 and 5A, material removed from the pipe section 12 is shown at 67 and in the chamfering of the pipe section as shown in FIGS. 6 and 6A, the material removed is shown as 85.

According to the preferred operation, rotation of the apparatus continues progressively cutting material away until groove cutting stop 69 engages the outer surface of the pipe section 12 to prevent further groove cutting, and the cutting stop 88 of chamfer cutting tool 84 engages the surface of the pipe section 12 to prevent further chamfering of the pipe section 12. However, until the point of engagement of the stop 88, the chamfer cutting is progressive and continuous. At the completion of the cutting operation, handles 76, 80 are still spaced from upper walls 70, 72, such that cutting stops 69, 88 provide the only interference to further cutting of the pipe section. Thereafter, the handles 76, 80 are rotated clockwise until they engage upper wall 70, 72. Further rotation of handles 76, 80 causes upward movement of rods 58, 78 so as to lift the cutting tools 62, 84 upwardly away from the pipe section 12 to clear the pipe section.

Crank 34 is then removed from nut 102 and replaced on nut 32. Thereafter, handle 34 is rotated in a counter-clockwise direction to cause cross member 24 and outer grip rollers 16, 18 to be lifted upwardly away for the outer surface of pipe section 12 sufficient to permit removal of the apparatus from the pipe section. The finished grooved and chamfered pipe section 12 is shown in FIG. 7 in condition for use with an appropriate coupling as described previously and the apparatus is ready to repeat the cut-grooving and chamfering operation.

While the apparatus 10 has been described in use for simultaneously cut grooving and chamfering a pipe section 12, alternative embodiments are contemplated wherein either of cutting tools 62, 84 may be retracted to provide only one cutting operation, assuming such pipe configuration is required for a particular use. The cutting operations may also be operated in sequence, if desired. In addition, as noted previously, the cutting tools 62, 84 may be alternatively configured to accommodate alternative and various pipe configurations and sizes, for example, cutting grooves of alternative shapes and dimension and chamfering pipe ends in alternative depths and angles or shapes. Accordingly, the provision of the feature providing removal and replacement of alternative cutting tools provides flexibility and variety in cutting pipe sections of varying sizes and configurations, with alternative sizes and shapes in the cuts thus provided.

It should be noted that a significant feature of the present invention is that the cut grooving and chamfering operations are performed simultaneously, continuously, and progressively. In particular, for a pipe section as shown, the pipe section can be continuously rotated until the cutting operations are complete. However, the unique structure of the present apparatus also makes it possible to cut groove, chamfer, or both, on workpieces other than pipe sections. For example, a flat plate section can be fed into the machine for cut grooving and/or chamfering by repeatedly passing the plate section through the machine in the same manner as with a pipe section. After the required number of passes have been completed, the cutting operation(s) will be completed.

In addition, as noted previously, the apparatus 10 can be made to cut groove and chamfer tubes of materials other than plastic, such as metal. However, minor modifications will be required, such as providing stronger springs 68, 78 to accommodate the harder material, and/or strengthening load carrying components.

Although the invention has been described in detail with reference to the illustrated preferred embodiments, variations and modifications may be provided within the scope and spirit of the invention as described and as defined by the following claims.

1. Apparatus for end cutting and cut grooving a cylindrical pipe section, which comprises:
a) a support frame;
b) means for positioning and gripping the pipe section for cutting and grooving portions thereof in fixed predetermined relation with respect to said frame;
c) end cutting means for cutting at least portions of the end of the pipe section to a predetermined shape, said end cutting means being positioned at a predetermined location with respect to said frame;
d) groove cutting means for cutting a groove in the outer surface portion of the pipe section, said groove cutting means being positioned at a predetermined location with respect to said frame; and
e) means for providing relative rotation between said frame and the pipe section to permit said end cutting means and said groove cutting means to cut the pipe section.

2. The apparatus for end cutting and cut grooving a cylindrical pipe section wherein said end cutting means is a cutting tool mounted and arranged for generally radial movement toward and away from the pipe section to cut a chamfer into the end of the pipe section.

3. The apparatus for end cutting and cut grooving a cylindrical pipe section according to claim 2, wherein said groove cutting means is a cutting tool mounted and arranged for generally radial movement toward and away from the pipe section.

4. The apparatus for end cutting and cut grooving a cylindrical pipe section according to claim 3, wherein said means for positioning and gripping the pipe section is a system of grip rollers selectively movable toward and away from the pipe section for gripping the pipe section, at least one roller positionable against the inside surface of the pipe section, and at least one roller positionable against the outside surface of the pipe section.

5. The apparatus for end cutting and cut grooving a cylindrical pipe section according to claim 4, wherein said grip rollers comprise at least two rollers positionable against the inner surface of the pipe section and at least two rollers positionable on the outer surface of the pipe section.

6. The apparatus for end cutting and cut grooving a cylindrical pipe section according to claim 5, wherein said two rollers positionable on the outer surface of the pipe section are mounted to a cross member extending transversely to the axis of the pipe section and movable toward and away from the pipe section respectively to grip the pipe section and to release the pipe section.

7. The apparatus for end cutting and cut grooving a cylindrical pipe section according to claim 6, wherein said at least two grip rollers positionable against the inner surface of the pipe section each have a frusto-conical configuration.

8. The apparatus for end cutting and cut grooving a cylindrical pipe section according to claim 7, wherein said chamfer cutting tool is attached to a threaded rod member movable toward and away from the pipe section.

9. The apparatus for end cutting and cut grooving a cylindrical pipe section according to claim 8, wherein said groove cutting tool is attached to a threaded rod member movable toward and away from the pipe section.

10. The apparatus for end cutting and cut grooving a cylindrical pipe section according to claim 9, wherein at least one of said frusto-conical rollers is attached to a rotational drive member to rotate said roller to cause said roller and said support frame to rotate about the pipe section when the pipe section is held fixed, or to cause the pipe section to rotate when said support frame is held fixed.

11. The apparatus for end cutting and cut grooving a cylindrical pipe section according to claim 10, wherein said rotational drive member includes a drive nut attached thereto which is rotatable by rotational engagement therewith by a nut driving member.

12. The apparatus for end cutting and cut grooving a cylindrical pipe section according to claim 11, wherein said transverse cross member is attached to a threaded rod member movable toward and away from the pipe section, said threaded rod member having a drive nut attached to one end thereof for rotatably driving said threaded rod member with a nut driving tool.

13. The apparatus for end cutting and cut grooving a cylindrical pipe section according to claim 12, wherein said chamfer cutting tool has a cutting stop associated therewith to prevent chamfer cutting past a predetermined depth.

14. The apparatus for end cutting and cut grooving a cylindrical pipe section according to claim 13, wherein said groove cutting tool has a cutting stop associated therewith to prevent further groove cutting past a predetermined depth.

15. Apparatus for cutting a cylindrical pipe section, which comprises:
a) a support frame;
b) a plurality of grip rollers adjustably movable toward and away from the respective inner and outer surfaces of the pipe section to grip the pipe section in a manner which permits relative rotation between said support frame and the pipe section;
c) at least one of pipe groove cutting means and pipe end cutting means associate with said support frame;
d) means for adjusting the position of said at least one of groove cutting means and end cutting means to cause engagement thereof with an outer surface portion of the pipe section, such that relative rotation of said frame and the pipe section, causes said at least one of groove cutting means and end cutting means to cut at least one of a groove and end cut on the outer portion of the pipe section; and
e) means for providing relative rotation between said grip rollers and the pipe section, at least two of said grip rollers having a shape and orientation with respect to said frame whereby the relative rotation between said frame and the pipe section provides self-tracking forces on the pipe section which maintain the pipe section in a predetermined axial location with respect to said frame.

16. Apparatus for cut grooving and chamfering a cylindrical pipe section, which comprises:
a) a support frame;
b) a plurality of grip rollers mounted to said support frame for gripping the pipe section to be cut grooved and chamfered in a manner which permits relative rotation between said support frame and the pipe section;
c) a pipe end chamfer cutter mounted to said support frame for chamfering the end portion of the pipe section to a predetermined chamfered shape;
d) a pipe groove cutter for cutting a groove into the outer surface portion of the pipe, said groove cutter being mounted at a predetermined position with respect to said frame for cutting engagement with the pipe section;
e) means for adjustably moving said chamfer cutter toward and away from the pipe section so as to permit said chamfer cutter to engage the outer surface portion of the pipe end;
f) resilient means to bias said chamfer cutter against the pipe section to cut the pipe section;
g) means for adjustably moving the pipe groove cutter toward and away from the pipe section so as to permit said pipe groove cutter to engage the outer surface portion of the pipe;
h) resilient means to bias said groove cutter against the outer surface portion of the pipe section to cut the pipe section; and
i) means for providing relative rotation between said frame and the pipe section to permit said pipe end chamfer cutter and said pipe groove cutter to engage and progressively cut the pipe section to form a chamfered end on the pipe section and to cut a groove into the outer surface portion of the pipe section.

17. The apparatus for cut grooving and chamfering a cylindrical pipe section according to claim 16, wherein said plurality of grip rollers comprise at least two rollers positionable against the inside surface of the pipe section and at least two rollers positionable against the outer surface of the pipe section for gripping the pipe section.

18. The apparatus for cut grooving and chamfering a cylindrical pipe section according to claim 17, wherein said at least two rollers positionable against the inside surface of the pipe section each have a frusto-conical configuration.

19. The apparatus for cut grooving and chamfering a cylindrical pipe section according to claim 18, wherein said pipe end chamfer cutting tool has a cutting stop attached thereto to prevent chamfer cutting of the end portion of the pipe section past a predetermined depth.

20. The apparatus for cut grooving and chamfering a cylindrical pipe section according to claim 19, wherein said pipe groove cutting tool has a cutting stop attached thereto to prevent groove cutting past a predetermined depth.

21. Apparatus for cut grooving and chamfering a cylindrical pipe section, which comprises:
a) a support frame;
b) means on said frame for positioning and gripping the pipe section with respect thereto for cutting and grooving portions thereof in fixed predetermined axial relation with respect to said frame;
c) pipe end cutting tool for cutting at least portions of the end of the pipe section to a predetermined chamfered shape, said pipe end cutting tool being positioned on said frame and movable toward and away from the pipe section when said frame is positioned adjacent the pipe section;
d) groove cutting tool for cutting a groove in an outer surface portion of the pipe section, said groove cutting tool being positioned at a predetermined location with respect to said frame and movable toward and away from the pipe section when said frame is positioned adjacent thereto; and
e) means for providing relative rotation between said frame and the pipe section to permit said end cutting tool and said groove cutting tool to progressively cut the pipe section, said means for positioning and gripping the pipe section having a shape and an orientation with respect to said frame whereby rotation of said gripping means causes relative rotation between said frame and the pipe section whereby self-tracking forces are developed therebetween which maintain the pipe section in said predetermined axial location with respect to said frame.

22. Apparatus for cut grooving and chamfering a cylindrical pipe section, which comprises:
a) a support frame;
b) means for positioning and gripping the pipe section for cutting and grooving portions thereof in fixed predetermined relation with respect to said frame;
c) pipe end cutting means for cutting at least portions of the end of the pipe to a predetermined shape, said end cutting means being positioned at a predetermined location with respect to said support frame;
d) groove cutting means for cutting a groove in the outer surface portion of the pipe, said groove cutting means being positioned at a predetermined location with respect to said frame; and
e) means for providing relative rotation between said frame and the pipe section to permit said pipe end cutting means and said groove cutting means to cut the pipe section, said means for receiving and gripping the pipe section having a shape and an orientation with respect to said frame whereby the relative rotation between said frame and the pipe section develops self-tracking forces which bias the pipe section toward said support frame so as to maintain the pipe section in said predetermined axial location with respect to said frame.

23. A method for cut grooving and chamfering a cylindrical pipe section on a support frame having means for positioning and gripping the pipe section in a manner which provides relative rotation between said support frame and the pipe section when at least one of said gripping means is rotated, comprising:
a) providing end cutting means for chamfer cutting at least portions of the end of the pipe section to a predetermined shape, said end cutting means being positioned at a predetermined location with respect to said frame and having means to bias said end cutting means toward the pipe section when the frame is mounted on the pipe section;
b) providing groove cutting means for cutting a groove in the outer surface portion of the pipe section, said groove cutting means being positioned at a predetermined location with respect to said frame and having means to bias said groove cutting means toward the pipe section when the frame is mounted on the pipe section; and
c) providing relative rotation between said frame and the pipe section to permit said end cutting means and said groove cutting means to progressively cut the pipe section under said bias forces.

24. A method for cut grooving and chamfering a cylindrical pipe section on an apparatus having a support frame, means for positioning and gripping the pipe section on the support frame and for providing relative rotation between said support frame and the pipe section, comprising:
a) providing a chamfer cutting tool on said support frame with means to bias said chamfer cutting tool toward the pipe section when the frame is positioned thereon;
b) providing a groove cutting tool on the support frame with means to bias groove cutting tool toward the pipe section when the frame is positioned thereon; and
c) providing relative rotation between said frame and the pipe section to permit said chamfer cutting tool and said groove cutting tool to progressively and continuously cut a chamfer and a groove into the pipe section as said frame is continuously rotated.

25. A method for simultaneously cut grooving a pipe section and chamfering and end portion of the pipe section on an apparatus having a support frame, means for gripping the pipe section with respect to the support frame, means resiliently engageable with the outer surface of the pipe section to cut a groove thereinto, means resiliently engageable with the end portion of the pipe section to chamfer cut the pipe section, which comprises:
a) positioning the pipe section adjacent said support frame and gripping the pipe section so as to fix the position of the pipe section with respect to said support frame;
b) positioning said cut grooving means in engagement with the outer surface of the pipe section for cut grooving;
c) positioning said chamfer cutting means in engagement with the end portion of the pipe section for chamfer cutting; and
d) providing relative rotation between said support frame and the pipe section to cause said cut grooving means and said chamfer cutting means to simultaneously cut groove and chamfer cut the pipe section.

26. The method according to claim 25, wherein said relative rotation continued until further groove cutting and chamfer cutting are prevented by engagement between a groove cutting stop member and a chamfer cutting stop member with respective adjacent outer surface portions of the pipe section.

27. A method for cut grooving a pipe section or chamfering and end portion of the pipe section on an apparatus having a support frame, means for gripping the pipe section with respect to the support frame, means resiliently engageable with the outer surface of the pipe section to cut a groove thereinto, means resiliently engageable with the end portion of the pipe section to chamfer cut the pipe section, which comprises:
a) positioning the pipe section adjacent said support frame and gripping the pipe section so as to fix the position of the pipe section with respect to said support frame;
b) positioning at least one of said cut grooving means and chamfer cutting means in engagement with the outer surface of the pipe section for at least one of cut grooving and chamfering the pipe section; and
c) providing relative rotation between said support frame and the pipe section to cause said at least one cut grooving means and chamfer cutting means to at least one of cut groove and chamfer cut the pipe section.
